(19) United States
(12) Patent Application Publication
(10) Pub. No.: US 2025/0008860 A1
(43) Pub. Date: Jan. 9, 2025

(54) SYSTEM AND METHOD FOR DETECTING DAMAGED DISK BLADES ON AN AGRICULTURAL IMPLEMENT

(71) Applicant: CNH Industrial America LLC, New Holland, PA (US)

(72) Inventor: Brittany Schroeder, Bunker Hill, IN (US)

(21) Appl. No.: 18/219,306

(22) Filed: Jul. 7, 2023

(51) Int. Cl. A01B 79/00; A01B 35/28

(52) U.S. Cl. CPC A01B 79/00; A01B 35/28

(57) ABSTRACT

A system for detecting damaged disk blades includes a disk blade assembly including a hanger having forward and aft arms coupled to a first and second disk blade, respectively. Additionally, the system includes a first load sensor configured to generate data indicative of a first load being applied to the forward arm and a second load sensor configured to generate data indicative of a second load being applied to the aft arm. Furthermore, the system includes a computing system configured to determine a first magnitude of the first load being applied to the forward arm based on the first load sensor data and determine a second magnitude of the second load being applied to the aft arm based second load sensor data. Moreover, the computing system is configured to determine when the first or second disk blades are damaged based on the determined first and second magnitudes.

### FIELD OF THE INVENTION

The present disclosure generally relates to agricultural implements and, more particularly, to a system and a method for detecting damaged disk blades on an agricultural implement.

### BACKGROUND OF THE INVENTION

It is well known that, to attain the best agricultural performance from a piece of land, a farmer must cultivate the soil, typically through a tillage operation. Common tillage operations include plowing, harrowing, and sub-soiling. Modern farmers perform these tillage operations by pulling a tillage implement behind an agricultural vehicle, such as a tractor. Depending on the crop selection and the soil conditions, a farmer may need to perform several tillage operations at different times over a crop cycle to properly cultivate the land to suit the crop choice.

In some configurations, a tillage implement includes a plurality of disk blades, such as leveling blades, supported on its frame. Each disk blade is coupled to a hanger via an armature, and each disk blade includes one or more bearings that couple the disk blade to the armature and allow the disk blade to easily rotate relative to the soil. As such, as the tillage implement travels across the field to perform a tillage operation thereon, the disk blades rotate relative to the soil to flatten soil ridges created by a plurality of shanks supported on the tillage implement frame.

After repeated tillage operations and disk blade use and/or upon disk blade contact with rocks and similar hard objects within the soil, the disk blades may become bent and/or otherwise damaged. A damaged disk blade may hinder the disk blade from rotating or prevent the disk blade from rotating entirely. Furthermore, the disk blades generally penetrate the soil at a selected depth to properly flatten the soil ridges. As such, a damaged disk blade may be positioned at a different penetration depth than the selected depth, thereby negatively impacting the quality of the tillage operation being performed. Thus, damaged disk blades should be replaced as soon as possible. However, it can be difficult for an operator to notice a damaged disk blade or a disk blade at different penetration depth than the selected penetration depth as the frame and/or the wheels of the tillage implement and/or the associated agricultural vehicle may block the operator's view of the disk blades during a tillage operation.

Accordingly, systems and methods for detecting damaged disk blades on an agricultural implement would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a system for detecting damaged disk blades on an agricultural implement. The system includes a disk blade assembly. The disk blade assembly includes a hanger having a forward arm and an aft arm. Furthermore, the disk blades assembly includes a first disk blade rotatably coupled to the forward arm and a second disk blade rotatably coupled to the aft arm. Moreover, the system includes a first load sensor mounted on the forward arm of the hanger and configured to generate data indicative of a first load being applied to the forward arm of the hanger. Additionally, the system includes a second load sensor mounted on the aft arm of the hanger and configured to generate data indicative of a second load being applied to the aft arm of the hanger. Furthermore, the system includes a computing system communicatively coupled to the first and second load sensors. The computing system is configured to determine a first magnitude of the first load being applied to the forward arm of the hanger based on the data generated by the first load sensor. Furthermore, the computing system is configured to determine a second magnitude of the second load being applied to the aft arm of the hanger based on the data generated by the second load sensor. Moreover, the computing system is configured to determine when the first or second disk blades are damaged based on the determined first and second magnitudes.

In another aspect, the present subject matter is directed to a method for detecting damaged disk blades on an agricultural implement. The agricultural implement includes a disk blade assembly having a hanger including a forward arm and an aft arm. The disk blade assembly further includes a first disk blade rotatably coupled to the forward arm and a second disk blade rotatably coupled to the aft arm. The method includes receiving, with a computing system, first load sensor data indicative of a first load being applied to the forward arm of the hanger. Additionally, the method includes determining, with the computing system, a first magnitude of the first load being applied to the forward arm of the hanger based on the data generated by the first load sensor. Furthermore, the method includes receiving, with the computing system, second load sensor data indicative of a second load being applied to an aft arm of the hanger. Moreover, the method includes determining, with the computing system, a second magnitude of the second load being applied to the aft arm of the hanger based on the data generated by the second load sensor. Additionally, the method includes determining, with the computing system, when the first or second disk blades are damaged based on the determined first and second magnitudes. Furthermore, the method includes initiating, with the computing system, a control action when it is determined that at least one of the first disk blade or the second disk blade is damaged.

In a further aspect, the present subject matter is directed to a system for detecting proper disk blade soil penetration depth on an agricultural implement. The system includes a disk blade assembly. The disk blade assembly includes a hanger having a forward arm and an aft arm. Furthermore, the disk blades assembly includes a first disk blade rotatably coupled to the forward arm and a second disk blade rotatably coupled to the aft arm. Moreover, the system includes a first load sensor mounted on the forward arm of the hanger and configured to generate data indicative of a first load being applied to the forward arm of the hanger. Additionally, the system includes a second load sensor mounted on the aft arm of the hanger and configured to generate data indicative of a second load being applied to the aft arm of the hanger. Furthermore, the system includes a computing system communicatively coupled to the first and second load sensors. The computing system is configured to determine a first magnitude of the first load being applied to the forward arm of the hanger based on the data generated by the first load sensor. Furthermore, the computing system is configured to determine a second magnitude of the second load being applied to the aft arm of the hanger based on the data generated by the second load sensor. Additionally, the computing system is configured to determine when the first or second disk blades are not at a selected soil penetration depth based on the determined first and second magnitudes.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of an agricultural implement and an associated agricultural vehicle in accordance with aspects of the present subject matter;

FIG. 2 illustrates a perspective view of one embodiment of a disk blade assembly of an agricultural implement in accordance with aspects of the present subject matter;

FIG. 3 illustrates a schematic view of one embodiment of a system for detecting disk blade damage on an agricultural implement in accordance with aspects of the present subject matter;

FIG. 4 illustrates a flow diagram providing one embodiment of control logic for detecting disk blade damage on an agricultural implement in accordance with aspects of the present subject matter;

FIG. 5 illustrates a flow diagram of one embodiment of a method for detecting disk blade damage on an agricultural implement in accordance with aspects of the present subject matter; and

FIG. 6 illustrates a flow diagram providing one embodiment of control logic for detecting proper disk blade soil penetration depth on an agricultural implement in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In general, the present subject matter is directed to a system and a method for detecting disk blade damage on an agricultural implement. As will be described below, the agricultural implement includes a disk blade assembly supported on its frame. The disk blade assembly, in turn, includes a hanger having a forward arm and an aft arm. The disk blade assembly also includes a first disk blade rotatably coupled to the forward arm and a second disk blade rotatably coupled to the aft arm. In this respect, the first disk blade and the second disk blade penetrate the soil of the field surface to flatten soil ridges as the agricultural implement travels across the field surface.

In several embodiments, a computing system of the disclosed system is configured to determine when the first or second disk blades are damaged (e.g., bent) based on the data generated by first and second load sensors. Specifically, in such embodiments, the first load sensor is mounted on the forward arm of the hanger and is configured to generate data indicative of a first load being applied to the forward arm. Additionally, in such embodiments, the second load sensor is mounted on the aft arm of the hanger and is configured to generate data indicative of a second load being applied to the aft arm. In this respect, the computing system is configured to determine when the first disk blade and/or the second disk blade are damaged (e.g., bent) based on the generated sensor data. For example, the computing system may determine first and second magnitudes of the first and second loads acting on the forward and aft arms of the hanger based on the received sensor data. Moreover, the computing system may determine a load differential between the first and second magnitudes and compare this load differential to a predetermined differential threshold. Thereafter, the computing system may compare the load differential to a predetermined differential threshold range and determine that the first disk blade is damaged when the load differential falls below the predetermined differential threshold value. The computing system may also determine that the second disk blade is damaged when the load differential exceeds the predetermined differential threshold range. Furthermore, the computing system may determine a number of times that the load differential falls below the predetermined differential threshold range within a time period and determine that the first disk blade is damaged (e.g., bent) when the number of times exceeds a minimum number of times. Likewise, the computing system may determine a number of times that the load differential exceeds the predetermined differential threshold range within a time period and determine that the second disk blade is damaged (e.g., bent) when the number of times exceeds a minimum number of times. Moreover, the computing system may initiate a control action if determined that at least one of the first or second disk blades are damaged (e.g., bent).

In several other embodiments, a computing system of the disclosed system is configured to determine whether the first or second disk blades are not at a selected soil penetration depth based on the data generated by the first and second load sensors as previously indicated. Specifically, in such embodiments, the computing system is configured to determine a soil penetration depth of the first disk blade within the soil of the field surface based on the determined first magnitude of the first load acting on the forward arm of the hanger. Additionally, in such embodiments, the computing system is configured to determine a soil penetration depth of the second disk blade within the soil of the field surface based on the determined second magnitude of the second load acting on the aft arm of the hanger. Furthermore, the computing system may compare the determined depths of the first and second disk blades to a predetermined depth threshold range. Thereafter, the computing system may determine when the first and/or second disk blades are not at the selected soil penetration depth when the soil penetration depth of the corresponding blade is outside of the predetermined depth threshold range. Moreover, the computing system may initiate a control action when determined that the soil penetration depth of the first and/or second disk blades are not at the selected soil penetration depth.

Detecting when the disk blades of an agricultural implement are damaged (e.g., bent) or not at a selected soil penetration depth based on the loads applied to the forward and aft arms of the hanger improves the operation of the agricultural implement. More specifically, during normal, undamaged operation of a disk blade, the difference between the loads applied to the forward and aft arms by the disk blades is generally negligible. Furthermore, the loading applied to each of the forward arm and the aft arm does not vary significantly at a particular soil penetration depth of a disk blade. However, when a bent disk blade moves through the soil, the load applied to each disk blade and, thus, its respective arm will often vary significantly within a specified time as the disk blade “bounces” through the soil. Furthermore, when only one of the two disk blades on a particular disk blade assembly is bent, the difference between the loading applied to the disk blades and, thus, the difference in loading applied to the forward and aft arms will increase or decrease depending on whether the first disk blade or the second disk blade is damaged (e.g., bent). The magnitude of the difference in loading between the disk blades is, in turn, indicative of the severity of the bending of a particular disk blade. Additionally, the magnitude of loading applied to a particular arm is indicative of the soil penetration depth of the disk blade coupled to that particular arm. As such, by monitoring the loads being applied to the forward and aft arms coupled to the disk blades of an agricultural implement, the disclosed systems and method can automatically determine when the disk blades of the agricultural implement are damaged (e.g., bent) and/or not at a selected soil penetration depth. Thus, the disclosed systems and method can notify the operator and/or initiate other control actions (e.g., reducing ground speed) when a disk blade is damaged (e.g., bent) and/or not at a selected soil penetration depth and without the need for the operator to notice such damage or improper depth, thereby improving the quality of the operation being performed by the agricultural implement.

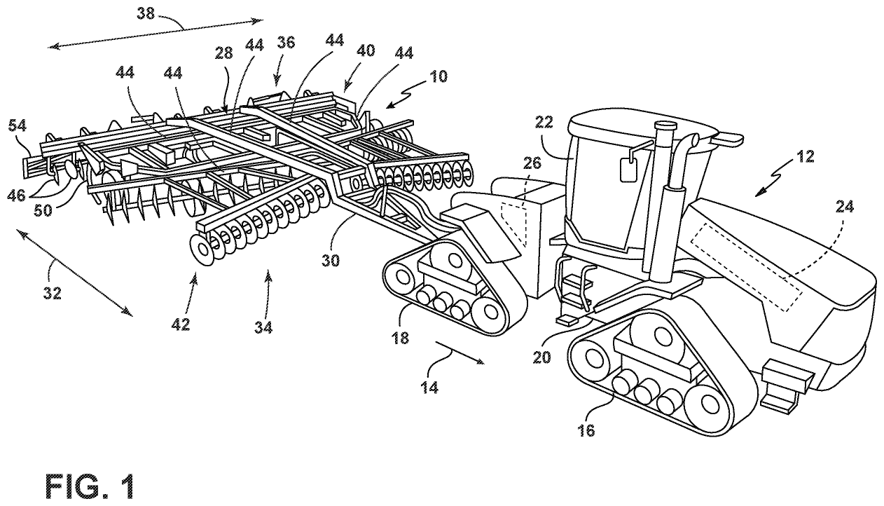

Referring now to the drawings, FIG. 1 illustrates a perspective view of one embodiment of an agricultural implement 10 and an associated agricultural vehicle 12 in accordance with aspects of the present subject matter. In general, the agricultural implement 10 is configured to be towed across a field by the agricultural vehicle 12 in a direction of travel (indicated by arrow 14). For example, in one embodiment, the agricultural implement 10 is configured as a tillage implement (e.g., a disk ripper) and the agricultural vehicle 12 is configured as an agricultural tractor. However, in other embodiments, the agricultural implement 10 may be configured as any other suitable agricultural implement, such as another type of tillage implement, a seeder, planter, nutrient applicator, etc. Similarly, the agricultural vehicle 12 may be configured as any other suitable agricultural vehicle, such as an agricultural harvester, a self-propelled sprayer, etc.

As shown, the agricultural vehicle 12 includes a pair of front track assemblies 16, a pair of rear track assemblies 18, and a frame or chassis 20 coupled to and supported by the track assemblies 16, 18. However, in other embodiments, the agricultural vehicle 12 may include any other type of traction devices, such as wheels or tires. An operator's cab 22 may be supported by a portion of the chassis 20 and may house various input devices (e.g., a user interface) for permitting an operator to control the operation of one or more components of the agricultural vehicle 12 and/or one or more components of the agricultural implement 10. Furthermore, the agricultural vehicle 12 includes an engine 24 and a transmission 26 mounted on the chassis 20. The transmission 26 may be operably coupled to the engine 24 and may provide variably adjusted gear ratios for transferring engine power to the track assemblies 16, 18 via a drive axle assembly (not shown) (or via axles if multiple drive axles are employed).

Additionally, the agricultural implement 10 includes a frame 28 configured to be towed by the agricultural vehicle 12 via a pull hitch or tow bar 30 in the direction of travel 14. As shown, the frame 28 extends in a longitudinal direction 32 between a forward end 34 of the frame 28 and an aft end 36 of the frame 28. The frame 28 also extends in a lateral direction 38 between a first side 40 of the frame 28 and a second side 42 of the frame 28. In general, the frame 28 may include a plurality of frame members 44, such as beams, bars, and/or the like, configured to support or couple to a plurality of components.

Moreover, the frame 28 may be configured to support a plurality of ground-engaging and/or ground-penetrating tools, such as a plurality of shank assemblies, disk blade assemblies (e.g., leveling blade assemblies), basket assemblies, tines, spikes, and/or the like. In one embodiment, the various ground-engaging and/or ground-penetrating tools may be configured to perform a tillage operation or any other suitable ground-engaging operation on the field across which the agricultural implement 10 is being towed. For example, in the illustrated embodiment, the frame 28 is configured to support various disk blade assemblies 46, such as leveling blade assemblies. The frame 28 is also configured to support a plurality of shank assemblies 50 and a plurality of crumbler wheels or basket assemblies 54. However, in alternative embodiments, the frame 28 may be configured to support any other suitable ground-engaging tool(s), ground-penetrating tool(s), or combinations of such tools.

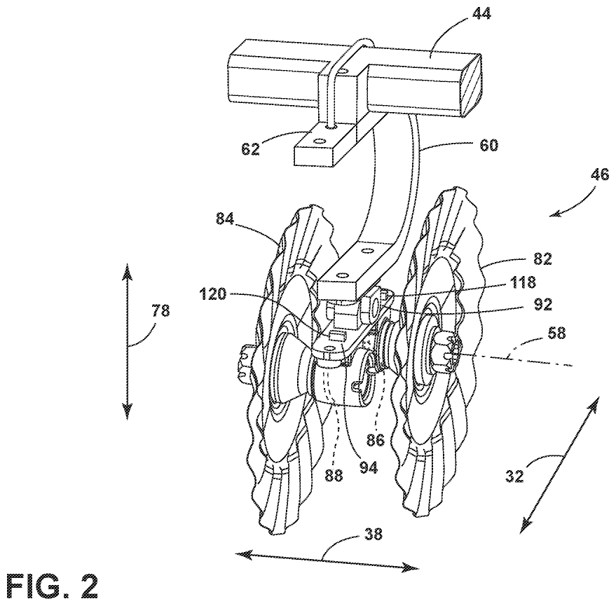

Referring now to FIG. 2, a perspective view of one embodiment of the disk blade assembly 46 of the agricultural implement 10 is illustrated. As shown, the disk blade assembly 46 includes the hanger 60 that is configured to support disk blades relative to the frame member 44. In this respect, the hanger 60 is coupled at one end to the frame member 44 via one or more fasteners (not shown). Additionally, the hanger 60 is coupled at the opposite end to the disk blades. In particular, the hanger 60 includes a forward arm 92 and an aft arm 94 separated from the forward arm 92 along the longitudinal direction 32 and the lateral direction 38. The forward arm 92 of the hanger 60 is rotatably coupled to a first disk blade 82. Likewise, the aft arm 94 of the hanger 60 is rotatably coupled to a second disk blade 84. As such, the first disk blade 82 is spaced apart from the second disk blade 84 along the longitudinal direction 32 and the lateral direction 38. In the illustrated embodiment, the hanger 60 defines a C-shape that permits the disk blades 82, 84 mounted thereon to move relative to the frame member 44. However, in alternative embodiments, the hanger 60 may have any other suitable configuration. Moreover, although the illustrated disk blade assembly 46 includes one hanger 60, the disk blade assembly 46 may have any other suitable number of hangers 60.

Furthermore, the disk blade assembly 46 includes the first disk blade 82 and the second disk blade 84. Each disk blade 82, 84 is rotatably supported by a respective disk blade bearing such that each disk blade 82, 84 rotates relative to the hanger 60. For example, the first disk blade 82 is supported by a first disk blade bearing 86 and the second disk blade 84 is supported by a second disk blade bearing 88. Specifically, in such embodiments, the first disk blade bearing 86 rotatably couples the first disk blade 82 to the forward arm 92 of the disk blade assembly 46. Likewise, in such embodiments, the second disk blade bearing 88 rotatably couples the second disk blade 84 to the aft arm 94 of the disk blade assembly 46. As such, each disk blade 82, 84 is generally configured to rotate about an axis 58 defined by each respective disk blade bearing 86, 88. Therefore, each disk blade 82, 84 may rotate independently about the axis 58 relative to each other disk blade 82, 84. However, in alternative embodiments, the disk blade assembly 46 may be configured in any other suitable manner.

During an agricultural operation (e.g., a tillage operation), the disk blades 82, 84 penetrate the soil and rotate relative to the soil as the agricultural implement 10 is towed across the field. Over time, repeated usage of the disk blades 82, 84 exposes the disk blades 82, 84 to repeated contact with rocks and similar hard objects within the soil. As such, the disk blade blades 82, 84 can bend or otherwise become damaged because of such repeated contact. Furthermore, to effectively flatten the soil ridges during tillage operations, the disk blades 82, 84 must penetrate the soil at an adequate depth. Unfortunately, it can be difficult for an operator to determine whether the disk blades 82, 84 are damaged (e.g., bent) and/or whether the disk blades 82, 84 have penetrated the soil at an adequate depth during a tillage operation as operator's view of the disk blades 82, 84 may be blocked. As will be described below, the systems and method disclosed herein will automatically determine whether the disk blades are damaged (e.g., bent) and/or not at a selected soil penetration depth and alert the operator of the damaged and/or improper depth.

It should be further appreciated that the configuration of the agricultural implement 10 and the agricultural vehicle 12 described above and shown in FIGS. 1-2 is provided only to place the present subject matter in an exemplary field of use. Thus, it should be appreciated that the present subject matter may be readily adaptable to any manner of agricultural implement and/or agricultural vehicle configuration.

Additionally, as shown in FIG. 2, the agricultural implement 10 includes a first load sensor 118. The first load sensor 118 is associated with the first disk blade 82 in that the first load sensor 118 is mounted on the forward arm 92 of the hanger 60. As such, the first load sensor 118 is configured to generate data indicative of a first load being applied to the forward arm 92 of the hanger 60, for example, by the first disk blade 82, in which the first load is indicative of the load applied to the first disk blade 82 by the field surface.

Furthermore, as shown in FIG. 2, the agricultural implement 10 includes a second load sensor 120. The second load sensor 120 is associated with the second disk blade 84 in that the second load sensor 120 is mounted on the aft arm 94 of the hanger 60. As such, the second load sensor 120 is configured to generate data indicative of a second load being applied to the aft arm 94 of the hanger 60, for example, by the second disk blade 84, in which the second load is indicative of the load applied to the second disk blade 84 by the field surface. As will be described below, the data generated by the first and second load sensors 118, 120 is used to determine when the first disk blade 82 and/or the second disk blade 84 is damaged (e.g., bent) and/or not at a selected soil penetration depth.

The first and second load sensors 118, 120 may be configured as any suitable sensors or sensing devices configured to generate data indicative of the loads being applied to or otherwise acting on the forward and aft arms 92, 94. For example, in some embodiments, the first and second load sensors 118, 120 may be configured as first and second load cells, respectively. However, in alternative embodiments, the first and second load sensors 118, 120 may be configured as any other suitable type of sensors or sensing devices, such as load pins, strain gauges, etc.

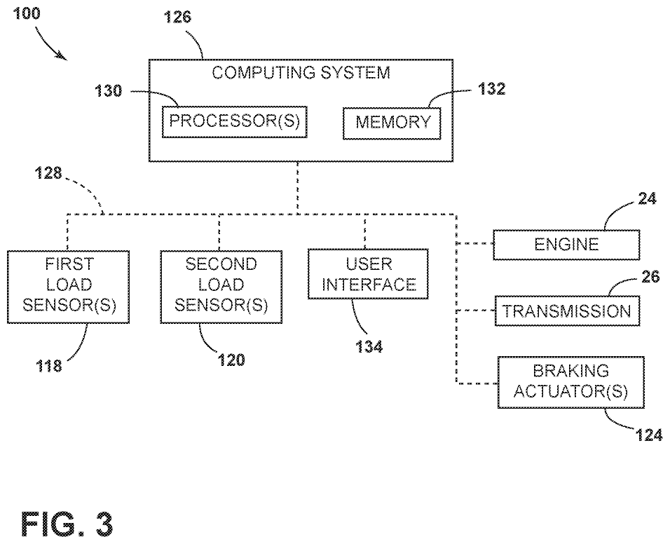

Referring now to FIG. 3, a schematic view of one embodiment of a system 100 for detecting disk blade damage on an agricultural implement 10 is illustrated in accordance with aspects of the present subject matter. In general, the system 100 will be described herein with reference to the agricultural implement 10 and the agricultural vehicle 12 described above with reference to FIGS. 1-2. However, it should be appreciated by those of ordinary skill in the art that the disclosed system 100 may generally be utilized with agricultural implements having any other suitable implement configuration and/or agricultural vehicles having any other suitable vehicle configuration.

As shown in FIG. 3, the system 100 includes one or more components of the agricultural implement 10 and/or the agricultural vehicle 12. For example, in the illustrated embodiment, the system 100 includes the engine 24, the transmission 26, the first load sensor(s) 118, and the second load sensor(s) 120.

Additionally, the system 100 may include one or more braking actuators 124 of the agricultural vehicle 12. In general, when activated, the braking actuator(s) 124 may reduce the speed at which the agricultural vehicle 12 moves across the field, such as by converting energy associated with the movement of the agricultural vehicle 12 into heat. For example, in one embodiment, the braking actuator(s) 124 may correspond to a suitable hydraulic cylinder(s) configured to push a stationary frictional element(s) (not shown), such as a brake shoe(s) or a brake caliper(s), against a rotating element(s) (not shown), such as a brake drum(s) or a brake disc(s). However, in alternative embodiments, the braking actuator(s) 124 may be any other suitable hydraulic, pneumatic, mechanical, and/or electrical component(s) configured to convert the rotation of the rotating element(s) into heat. In addition, in embodiments in which speed control can be actuated by the throttle body position, the braking actuator(s) 124 may be omitted.

Moreover, the system 100 includes a computing system 126 communicatively coupled to one or more components of the agricultural implement 10, the agricultural vehicle 12, and/or the system 100 to allow the operation of such components to be electronically or automatically controlled by the computing system 126. For instance, the computing system 126 may be communicatively coupled to the first and second load sensors 118, 120 via a communicative link 128. As such, the computing system 126 may be configured to receive data from the first and second sensors 118, 120 that is indicative of the loads being applied to the forward arm 92 and aft arm 94 of the hanger 60 coupling the disk blade assembly(ies) 46 to the frame 28. Furthermore, the computing system 126 may be communicatively coupled to the engine 24, the transmission 26, and/or the braking actuator(s) 124 via the communicative link 128. In this respect, the computing system 126 may be configured to control the operation of the engine 24, the transmission 26, and/or the braking actuator(s) 124 to adjust the ground speed at which the agricultural implement 10 travels across the field. In addition, the computing system 126 may be communicatively coupled to any other suitable components of the agricultural implement 10, the agricultural vehicle 12, and/or the system 100.

In general, the computing system 126 may comprise any suitable processor-based device known in the art, such as a given controller or computing device or any suitable combination of controllers or computing devices. Thus, in several embodiments, the computing system 126 may include one or more processor(s) 130 and associated memory device(s) 132 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 132 of the computing system 126 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 132 may generally be configured to store suitable computer-readable instructions that, when implemented by the processor(s) 130, configure the computing system 126 to perform various computer-implemented functions, such as one or more aspects of the methods and algorithms that will be described herein. In addition, the computing system 126 may also include various other suitable components, such as a communications circuit or module, one or more input/output channels, a data/control bus and/or the like.

It should be appreciated that the computing system 126 may correspond to an existing computing system(s) of the agricultural implement 10 and/or the agricultural vehicle 12, itself, or the computing system 126 may correspond to a separate processing device. For instance, in one embodiment, the computing system 126 may form all or part of a separate plug-in module that may be installed in association with the agricultural implement 10 and/or the agricultural vehicle 12 to allow for the disclosed systems to be implemented without requiring additional software to be uploaded onto existing control devices of the agricultural implement 10 and/or the agricultural vehicle 12. It should also be appreciated that the functions of the computing system 126 may be performed by a single processor-based device or may be distributed across any number of processor-based devices, in which instance such devices may be considered to form part of the computing system 126. For instance, the functions of the computing system 126 may be distributed across multiple application-specific controllers or computing devices, such as a navigation controller, an engine computing controller, a transmission controller, an implement controller and/or the like.

In addition, the system 100 may also include a user interface 134. More specifically, the user interface 134 may be configured to provide feedback, such as feedback associated with disk blade damage and/or improper soil penetration depth to the operator. As such, the user interface 134 may include one or more feedback devices (not shown), such as display screens, speakers, warning lights, and/or the like, which are configured to provide feedback from the computing system 126 to the operator. As such, the user interface 134 may, in turn, be communicatively coupled to the computing system 126 via the communicative link 128 to permit the feedback to be transmitted from the computing system 126 to the user interface 134. Furthermore, some embodiments of the user interface 134 may include one or more input devices, such as touchscreens, keypads, touchpads, knobs, buttons, sliders, switches, mice, microphones, and/or the like, which are configured to receive inputs from the operator. In one embodiment, the user interface 134 may be mounted or otherwise positioned within the operator's cab 22 of the agricultural vehicle 12. However, in alternative embodiments, the user interface 134 may mounted at any other suitable location.

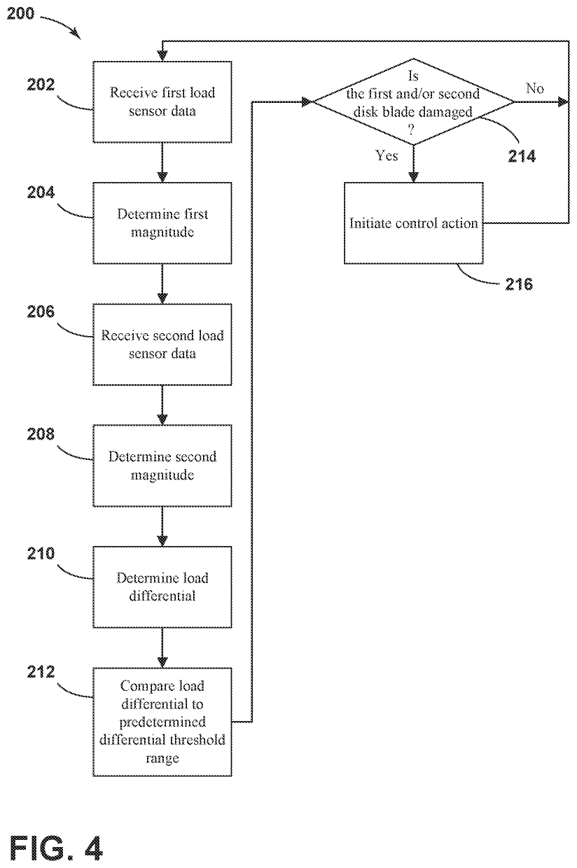

Referring now to FIG. 4, a flow diagram of one embodiment of example control logic 200 that may be executed by the computing system 126 (or any other suitable computing system) for detecting disk blade damage on an agricultural implement is illustrated in accordance with aspects of the present subject matter. Specifically, the control logic 200 shown in FIG. 4 is representative of steps of one embodiment of an algorithm that can be executed to automatically detect disk blade damage (e.g., bending) on an agricultural implement. Thus, in several embodiments, the control logic 200 may be advantageously utilized in association with a system installed on or forming part of an agricultural implement and/or an associated agricultural vehicle to allow for real-time detection, for example, without operator input, of disk blade damage (e.g., bending) on an agricultural implement without requiring substantial computing resources and/or processing time. However, in other embodiments, the control logic 200 may be used in association with any other suitable system, application, and/or the like for detecting disk blade damage (e.g., bending) on an agricultural implement.

As shown in FIG. 4, at (202), the control logic 200 includes receiving first load sensor data indicative of a first load being applied to a forward arm of a hanger of a disk blade assembly of an agricultural implement. Specifically, as mentioned above, in several embodiments, the computing system 126 may be communicatively coupled to the first load sensor(s) 118 via the communicative link 128. In this respect, as the agricultural implement 10 is towed across the field by the agricultural vehicle 12 to perform an agricultural operation (e.g., a tillage operation) thereon, the computing system 126 may receive data from the first load sensor(s) 118. Such first load sensor data may, in turn, be indicative of the load being applied to the forward arm(s) 92 by the first disk blade(s) 82 of the agricultural implement 10, and thus indicative of the load being applied by the field surface to the first disk blade(s) 82.

Furthermore, as shown in FIG. 4, at (204), the control logic 200 includes determining a first magnitude of the first load acting on the forward arm of the hanger based on the data generated by the first load sensor. Specifically, in several embodiments, the computing system 126 is configured to analyze the first load sensor data received at (202) to determine the first magnitude of the first load acting on the forward arm 92 coupling the first disk blade 82 to the hanger 60. For example, the computing system 126 may access a look-up table stored within its memory device(s) 132 that correlates the received first load sensor data to the corresponding first magnitude(s).

Moreover, as shown in FIG. 4, at (206), the control logic 200 includes receiving second load sensor data indicative of a second load being applied to an aft arm of the hanger of the disk blade assembly of the agricultural implement. Specifically, as mentioned above, in several embodiments, the computing system 126 may be communicatively coupled to the second load sensor(s) 120 via the communicative link 128. In this respect, as the agricultural implement 10 is towed across the field by the agricultural vehicle 12 to perform the agricultural operation, the computing system 126 may receive data from the second load sensor(s) 120. Such second load sensor data may, in turn, be indicative of the load being applied to the aft arm 94 by the second disk blade 84 of the agricultural implement 10, and thus indicative of the load being applied by the field surface to the second disk blade 84.

Additionally, as shown in FIG. 4, at (208), the control logic 200 includes determining a second magnitude of the second load acting on the aft arm of the hanger based on the data generated by the second load sensor. Specifically, in several embodiments, the computing system 126 is configured to analyze the second load sensor data received at (206) to determine the second magnitude of the second load acting on the aft arm 94 coupling the second disk blade 84 to the hanger 60. For example, the computing system 126 may access a look-up table stored within its memory device(s) 132 that correlates the received second load sensor data to the corresponding second magnitude(s).

Moreover, as shown in FIG. 4, at (210), the control logic 200 includes determining a load differential between the first magnitude and the second magnitude. Specifically, in several embodiments, the computing system 126 is configured to determine the difference between the first magnitude determined at (204) and the second magnitude determined at (208) to determine the load differential between the first magnitude and the second magnitude. For example, the computing system 126 may subtract the second magnitude from the first magnitude or the first magnitude from the second magnitude to determine the load differential between the first magnitude and the second magnitude.

Furthermore, as shown in FIG. 4, at (212), the control logic 200 includes comparing the load differential to a predetermined differential threshold range. Specifically, in several embodiments, the computing system 126 is configured to compare each load differential determined at (210) to a predetermined differential threshold range to determine when the load differential exceeds or falls below the predetermined differential threshold range. Additionally, in several embodiments, the computing system 126 is configured to determine a number of times that the load differential exceeds, and/or a number of times that the load differential falls below, the predetermined threshold range within a time period.

The first load sensor data received at (202) and the second load sensor data received at (206) are used to determine whether each of the disk blades 82, 84 of the agricultural implement 10 are damaged (e.g., bent). During normal, undamaged (e.g., unbent) operation of the disk blades 82, 84, a load is applied to the corresponding arm 82, 84 with a negligible difference between the load applied to the forward arm 82 and the load applied to the aft arm 84. However, when one of the two disk blades 82, 84 is damaged (e.g., bent), the damaged (e.g., bent) disk blade 82, 84 experiences a resistance in rotation and disk blade 82, 84 tends to bounce across the field surface with varying loads applied to the respective arm 92, 94. As such, the load differential between the forward arm 92 and the aft arm 94 may indicate which disk blade 82, 84 is damaged (e.g., bent). As such, a positive differential indicates that the disk blade 82 is damaged (e.g., bent) and a negative differential indicates that the disk blade 84 is damaged (e.g., bent). Furthermore, the magnitude of the load differential may indicate the severity of the damage (e.g., bending). However, it should be appreciated that a positive differential may indicate that the disk blade 84 is damaged (e.g., bent) and a negative differential may indicate that the disk blade 82 is damaged (e.g., bent).

Furthermore, as shown in FIG. 4, at (214), the control logic 200 includes determining that the first disk blade or the second disk blade is damaged. For example, when the load differential applied to the forward and aft arms 92, 94 falls below the predetermined differential threshold range, the first disk blade 82 is damaged (e.g., bent). Additionally, in several embodiments, when the number of times that the load differential applied to the forward and aft arms 92, 94 falls below the predetermined differential threshold range exceeds a minimum numbers of times, the first disk blade 82 is damaged (e.g., bent). Moreover, when load differential applied to the forward and aft arms 92, 94 exceeds the predetermined differential threshold range, the second disk blade 84 is damaged (e.g., bent). Furthermore, in several embodiments when the number of times that the load differential applied to the forward and aft arms 92, 94 exceeds the predetermined differential threshold range exceeds a minimum number of times, the second disk blade 84 is damaged (e.g., bent). In such instances when at least one of the first disk blade 82 or the second disk blade 84 is damaged (e.g., bent), the control logic 200 (with respect to that corresponding disk blade 82, 84) proceeds to (216) at which the computing system 126 is configured to initiate one or more control actions. Conversely, when the load differential does not fall below or exceed the predetermined differential threshold range or the number of times that the load differential falls below or exceeds the predetermined differential threshold range does not exceed the minimum number of times, the control logic 200 proceeds back to (202).

Additionally, as shown in FIG. 4, at (216), the computing system 126 may be configured to initiate one or more control actions. For example, in some embodiments, the computing system 126 may be configured to initiate notification of the operator of the agricultural implement 10 that one or more of the disk blades 82, 84 are damaged (e.g., bent). In this respect, the computing system 126 may be configured to initiate notification of the operator of the agricultural implement 10 that the first disk blade 82 is damaged (e.g., bent) and/or the second disk blade 86 is damaged (e.g., bent). In such embodiments, the computing system 126 may transmit control signals to the user interface 134 via the communicative link 128. Such control signals may, in turn, instruct the user interface 134 to provide a visual or audible notification to the operator that one or more of the disk blades 82, 84 are damaged (e.g., bent). In one embodiment, the notification may indicate which one of the disk blades 82, 84 is damaged (e.g., bent). For example, the notification may indicate that the first disk blade 82 and/or the second disk blade 84 is damaged (e.g., bent).

Additionally, or alternatively, at (216), the computing system 126 may be configured to adjust the ground speed of the agricultural implement 10 (e.g., reduce the ground speed of or stop the agricultural implement 10). For example, the computing system 126 may transmit control signals to the engine 24, the transmission 26, and/or the braking actuator(s) 124 via the communicative link 128. Such control signals may, in turn, instruct the engine 24, the transmission 26, and/or the braking actuator(s) 124 to adjust the ground speed of the agricultural vehicle 12 and, thus, the agricultural implement 10 (e.g., reduce the ground speed of or stop the agricultural implement 10). Moreover, other automatic control actions (e.g., adjusting force being applied to and/or the penetration depth of the disk blade assembly(ies) 46) may be initiated after it is determined that one or more of the disk blades 82, 84 are bent. Upon completion of (216), the control logic 200 proceeds to (202).

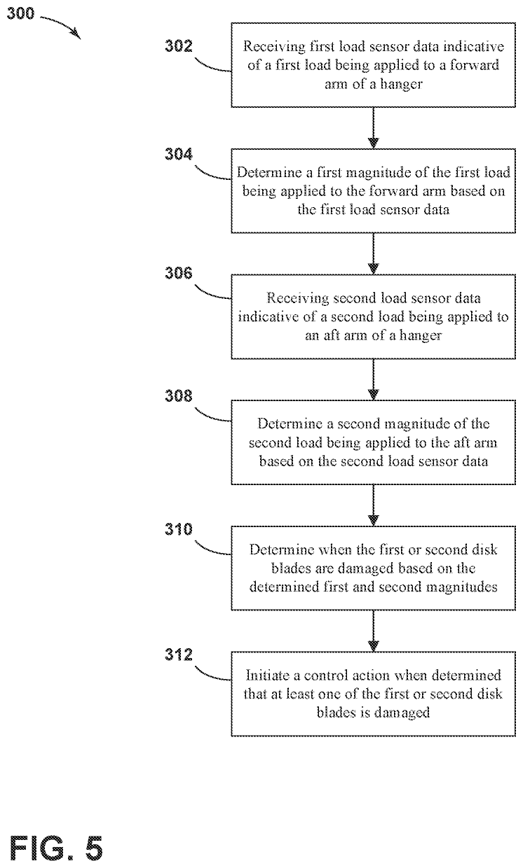

Referring now to FIG. 5, a flow diagram of one embodiment of a method 300 for detecting disk blade damage on an agricultural implement is illustrated in accordance with aspects of the present subject matter. In general, the method 300 will be described herein with reference to the agricultural implement 10, the agricultural vehicle 12, and the system 100 described above with reference to FIGS. 1-4. However, it should be appreciated by those of ordinary skill in the art that the disclosed method 300 may generally be implemented with any agricultural implement having any suitable implement configuration, with any agricultural vehicle having any suitable vehicle configuration, and/or within any system having any suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (302), the method 300 includes receiving, with a computing system, first load sensor data indicative of a first load being applied to a forward arm of a hanger. For instance, as described above in reference to FIG. 3, the computing system 126 may be configured to receive first load sensor data from the first load sensor(s) 118 via the communicative link 128. The received first load sensor data is, in turn, indicative of a first load(s) being applied to the forward arm 92, for example, by the first disk blade 82.

Additionally, as shown in FIG. 5, at (304), the method 300 includes determining, with the computing system, a first magnitude of the first load being applied to the forward arm of the hanger based on the data generated by the first load sensor. For instance, as described above in reference to FIG. 4, the computing system 126 may be configured to analyze the first load sensor data to determine the first magnitude of the first load acting on the forward arm 92 coupling the first disk blade 82 to the hanger 60. For example, the computing system 126 may access a look-up table stored within its memory device(s) 132 that correlates the received first load sensor data to the corresponding first magnitude(s).

Furthermore, as shown in FIG. 5, at (306), the method 300 includes receiving, with the computing system, second load sensor data indicative of a second load being applied to an aft arm of the hanger. For instance, as described above in reference to FIG. 3, the computing system 126 may be configured to receive second load sensor data from the second load sensor(s) 120 via the communicative link 128. The received first load sensor data is, in turn, indicative of a second load(s) being applied to the aft arm 94, for example, by the second disk blade 84.

Moreover, as shown in FIG. 5, at (308), the method 300 includes determining, with the computing system, a second magnitude of the second load being applied to the aft arm of the hanger based on the data generated by the second load sensor. For instance, as described above in reference to FIG. 4, the computing system 126 may be configured to analyze the second load sensor data to determine the second magnitude of the second load acting on the aft arm 94 coupling the second disk blade 84 to the hanger 60. For example, the computing system 126 may access a look-up table stored within its memory device(s) 132 that correlates the received second load sensor data to the corresponding second magnitude(s).

Additionally, as shown in FIG. 5, at (310), the method 300 includes determining, with the computing system, when the first or second disk blades are damaged based on the determined first and second magnitudes. For instance, as described above in reference to FIG. 4, the computing system 126 may be configured to determine a load differential between the first magnitude and the second magnitude, compare the load differential to a predetermined differential threshold range, and determine that the first and/or second disk blades are damaged when the load differential falls below or exceeds the predetermined differential threshold range.

Furthermore, as shown in FIG. 5, at (312), the method 300 includes initiating, with the computing system, a control action when it is determined that at least one of the first disk blade or the second disk blade is damaged. For instance, as described above in reference to FIG. 3, the computing system 126 may be communicatively coupled to the engine 24, the transmission 26, and/or the braking actuator(s) 124 via the communicative link 128. In this respect, the computing system 126 may be configured to control the operation of the engine 24, the transmission 26, and/or the braking actuator(s) 124 to adjust the ground speed at which the agricultural implement 10 travels across the field. Furthermore, as described above in reference to FIG. 3, the user interface 134 may be communicatively coupled to the computing system 126 via the communicative link 128 to permit feedback to be transmitted from the computing system 126 to the user interface 134, such as feedback associated with disk blade 82, 84 damage and/or improper soil penetration depth.

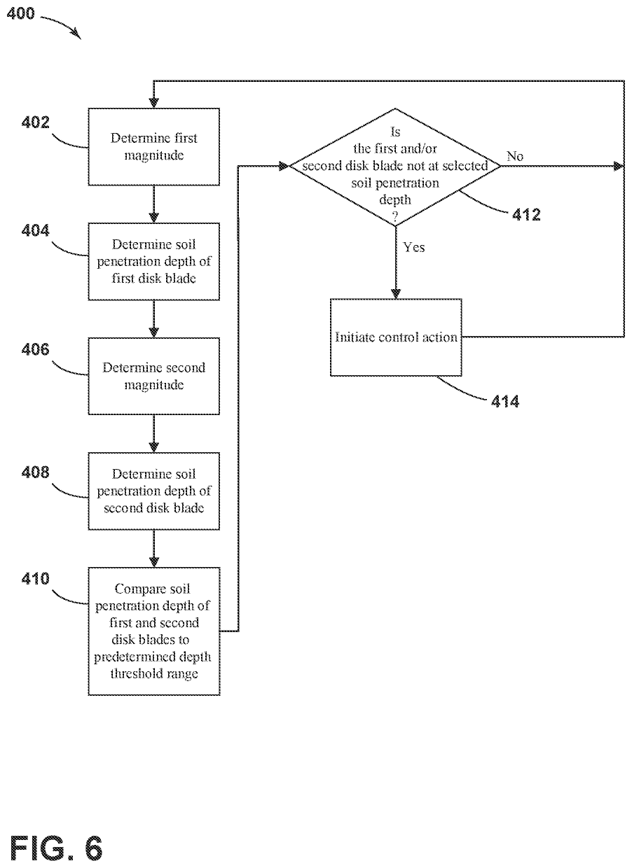

Referring now to FIG. 6, a flow diagram of one embodiment of example control logic 400 that may be executed by the computing system 126 (or any other suitable computing system) for proper disk blade soil penetration depth on an agricultural implement is illustrated in accordance with aspects of the present subject matter. Specifically, the control logic 400 shown in FIG. 6 is representative of steps of one embodiment of an algorithm that can be executed to automatically detect proper disk blade soil penetration depth on an agricultural implement. Thus, in several embodiments, the control logic 400 may be advantageously utilized in association with a system installed on or forming part of an agricultural implement and/or an associated agricultural vehicle to allow for real-time detection, for example, without operator input, of proper disk blade soil penetration depth on an agricultural implement without requiring substantial computing resources and/or processing time. However, in other embodiments, the control logic 400 may be used in association with any other suitable system, application, and/or the like for detecting proper disk blade soil penetration depth on an agricultural implement.

As shown in FIG. 6, at (402), the control logic 400 includes determining a first magnitude of a first load being applied to a forward arm of a hanger based on data generated by a first load sensor. Specifically, in several embodiments, the computing system 126 is configured to analyze the data generated by the first load sensor 118 to determine the first magnitude of the first load acting on the forward arm 92 coupling the first disk blade 82 to the hanger 60. For example, the computing system 126 may access a look-up table stored within its memory device(s) 132 that correlates the received first load sensor data to the corresponding first magnitude(s).

Additionally, as shown in FIG. 6, at (404), the control logic 400 includes determining a soil penetration depth of a first disk blade based on the determined first magnitude. Specifically, in several embodiments, the computing system 126 is configured to analyze the determined first magnitude to determine the soil penetration depth of the first disk blade 82. For example, the computing system 126 may access a look-up table stored within its memory device(s) 132 that correlates the determined first magnitude to the corresponding soil penetration depth of the first disk blade 82.

Furthermore, as shown in FIG. 6, at (406), the control logic 400 includes determining a second magnitude of a second load being applied to an aft arm of the hanger based on data generated by a second load sensor. Specifically, in several embodiments, the computing system 126 is configured to analyze the data generated by the second load sensor 120 to determine the second magnitude of the second load acting on the aft arm 94 coupling the second disk blade 84 to the hanger 60. For example, the computing system 126 may access a look-up table stored within its memory device(s) 132 that correlates the received second load sensor data to the corresponding second magnitude(s).

Moreover, as shown in FIG. 6, at (408), the control logic 400 includes determining a soil penetration depth of the second disk blade based on the determined second magnitude. Specifically, in several embodiments, the computing system 126 is configured to analyze the determined second magnitude to determine the soil penetration depth of the second disk blade 84. For example, the computing system 126 may access a look-up table stored within its memory device(s) 132 that correlates the determined second magnitude to the corresponding soil penetration depth of the second disk blade 84.

Additionally, as shown in FIG. 6, at (410), the control logic 400 includes comparing the determined soil penetration depth of the first and second disk blades to a predetermined depth threshold range. Specifically, in several embodiments, the computing system 126 is configured to compare each determined soil penetration depth at (404) and (408) to a predetermined depth threshold range to determine when the determined soil penetration depth of the first and/or second disk blades 82, 84 are outside of (e.g., exceed or fall below) the predetermined depth threshold range.

Furthermore, as shown in FIG. 6, at (412), the control logic 400 includes determining that the soil penetration depth of the first or second disk blades are not at the selected soil penetration depth when the determined soil penetration depth of the first or second disk blades are outside of the predetermined depth threshold range. For example, when the determined soil penetration depth of the first and/or second disk blades 82, 84 are outside of (e.g., exceed or fall below) the predetermined depth threshold range, the first and/or second disk blade 82, 84 are not at the selected soil penetration depth. In such instances when at least one of the first disk blade 82 or the second disk blade 84 is not at the selected soil penetration depth, the control logic 400 (with respect to that corresponding disk blade 82, 84) proceeds to (414) at which the computing system 126 is configured to initiate one or more control actions. Conversely, when the determined soil penetration depth of the first and/or second disk blades 82, 84 are not outside of (e.g., within) the predetermined depth threshold range, the control logic 400 proceeds back to (402).

Moreover, as shown in FIG. 6, at (414), the control logic 400 initiating a control action when determined that the soil penetration depth of the first or second disk blades are not at the selected soil penetration depth. For example, in some embodiments, the computing system 126 may be configured to initiate notification of the operator of the agricultural implement 10 that one or more of the disk blades 82, 84 are not at the selected soil penetration depth. In this respect, the computing system 126 may be configured to initiate notification of the operator of the agricultural implement 10 that the first disk blade 82 and/or the second disk blade 86 is not at the selected soil penetration depth. In such embodiments, the computing system 126 may transmit control signals to the user interface 134 via the communicative link 128. Such control signals may, in turn, instruct the user interface 134 to provide a visual or audible notification to the operator that one or more of the disk blades 82, 84 are not at the selected soil penetration depth. In one embodiment, the notification may indicate which one of the disk blades 82, 84 is not at the selected soil penetration depth. For example, the notification may indicate that the first disk blade 82 and/or the second disk blade 84 is not at the selected soil penetration depth.

Additionally, or alternatively, at (414), the computing system 126 may be configured to adjust the ground speed of the agricultural implement 10 (e.g., reduce the ground speed of or stop the agricultural implement 10). For example, the computing system 126 may transmit control signals to the engine 24, the transmission 26, and/or the braking actuator(s) 124 via the communicative link 128. Such control signals may, in turn, instruct the engine 24, the transmission 26, and/or the braking actuator(s) 124 to adjust the ground speed of the agricultural vehicle 12 and, thus, the agricultural implement 10 (e.g., reduce the ground speed of or stop the agricultural implement 10). Moreover, other automatic control actions (e.g., adjusting force being applied to and/or the penetration depth of the disk blade assembly(ies) 46) may be initiated after it is determined that one or more of the disk blades 82, 84 are not at the selected soil penetration depth. Upon completion of (414), the control logic 400 proceeds to (402).

It is to be understood that the steps of the control logic 200, the method 300, and the control logic 400 are performed by the computing system 126 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 126 described herein, such as the control logic 200, the method 300, and the control logic 400, is implemented in software code or instructions which are tangibly stored on a tangible computer readable medium. The computing system 126 loads the software code or instructions via a direct interface with the computer readable medium or via a wired and/or wireless network. Upon loading and executing such software code or instructions by the computing system 126, the computing system 126 may perform any of the functionality of the computing system 126 described herein, including any steps of the control logic 200 the method 300, and the control logic 400 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A system for detecting damaged disk blades on an agricultural implement, the system comprising:
a disk blade assembly including a hanger having a forward arm and an aft arm, the disk blade assembly further including a first disk blade rotatably coupled to the forward arm and a second disk blade rotatably coupled to the aft arm;
a first load sensor mounted on the forward arm of the hanger and configured to generate data indicative of a first load being applied to the forward arm of the hanger;
a second load sensor mounted on the aft arm of the hanger and configured to generate data indicative of a second load being applied to the aft arm of the hanger; and
a computing system communicatively coupled to the first and second load sensors, the computing system configured to:
determine a first magnitude of the first load being applied to the forward arm of the hanger based on the data generated by the first load sensor;
determine a second magnitude of the second load being applied to the aft arm of the hanger based on the data generated by the second load sensor; and
determine when the first or second disk blades are damaged based on the determined first and second magnitudes.

2. The system of claim 1, wherein:
a frame of the agricultural implement extends in a longitudinal direction between a forward end of the frame and an aft end of the frame, the frame further extending in a lateral direction between a first side of the frame and a second side of the frame;
the forward arm and an aft arm are spaced apart from each other along the longitudinal direction and the lateral direction; and
the first disk blade is at least partially spaced apart from the second disk blade along the longitudinal direction and spaced apart from the second disk blade along the lateral direction relative to the frame.

3. The system of claim 1, wherein, when determining when the first or second disk blades are damaged, the computing system is further configured to:
determine a load differential between the first magnitude and the second magnitude; and
determine when the first or second disk blades are damaged based on the determined load differential.

4. The system of claim 3, wherein, when determining when the first or second disk blades are damaged, the computing system is further configured to:
compare the load differential to a predetermined differential threshold range; and
determine that the first disk blade is damaged when the load differential falls below the predetermined differential threshold range.

5. The system of claim 3, wherein, when determining when the first or second disk blade are damaged, the computing system is further configured to:
compare the load differential to a predetermined differential threshold range; and
determine that the second disk blade is damaged when the load differential exceeds the predetermined differential threshold range.

6. The system of claim 4, wherein, when determining when the first blade is damaged, the computing system is further configured to:
determine a number of times that the load differential falls below the predetermined differential threshold range within a time period; and
determine that the first disk blade is damaged when the number of times that the load differential falls below the predetermined differential threshold range within the time period exceeds a minimum number of times.

7. The system of claim 5, wherein, when determining when the second disk blade is damaged, the computing system is further configured to:
determine a number of times that the load differential exceeds the predetermined differential threshold range within a time period; and
determine that the second disk blade is damaged when the number of times that the load differential exceeds the predetermined differential threshold range within the time period exceeds a minimum number of times.

8. The system of claim 1, wherein, when it is determined that at least one of the first disk blade or the second disk blade is damaged, the computing system is further configured to initiate a control action.

9. The system of claim 8, wherein the control action comprises notifying an operator of the agricultural implement that at least one of the first disk blade or the second disk blade is damaged.

10. The system of claim 8, wherein the control action comprises adjusting a ground speed of the agricultural implement.

11. The system of claim 1, wherein the first disk blade comprises a first level disk blade and the second disk blade comprises a second level disk blade.

12. A method for detecting damaged disk blades on an agricultural implement, the agricultural implement including a disk blade assembly having a hanger, the hanger including a forward arm and an aft arm, the disk blade assembly further including a first disk blade rotatably coupled to the forward arm and a second disk blade rotatably coupled to the aft arm, the method comprising:
receiving, with a computing system, first load sensor data indicative of a first load being applied to the forward arm of the hanger;
determining, with the computing system, a first magnitude of the first load being applied to the forward arm of the hanger based on the data generated by the first load sensor;
receiving, with the computing system, second load sensor data indicative of a second load being applied to the aft arm of the hanger;
determining, with the computing system, a second magnitude of the second load being applied to the aft arm of the hanger based on the data generated by the second load sensor;
determining, with the computing system, when the first or second disk blades are damaged based on the determined first and second magnitudes; and
initiating, with the computing system, a control action when it is determined that at least one of the first disk blade or the second disk blade is damaged.

13. The method of claim 12, further comprising:
determining, with the computing system, a load differential between the first magnitude and the second magnitude; and
determining, with the computing system, that the first or second disk blades are damaged based on the determined load differential.

14. The method of claim 13, further comprising:
comparing, with the computing system, the load differential to a predetermined differential threshold range; and
determining, with the computing system, that the first disk blade is damaged when the load differential falls below the predetermined differential threshold range.

15. The method of claim 13, further comprising:
comparing, with the computing system, the load differential to a predetermined differential threshold range; and
determining, with the computing system, that the second disk blade is damaged when the load differential exceeds the predetermined differential threshold range.

16. The method of claim 14, further comprising:
determining, with the computing system, a number of times that the load differential falls below the predetermined differential threshold range within a time period; and
determining, with the computing system, that the first disk blade is damaged when the number of times that the load differential falls below the predetermined differential threshold range within the time period exceeds a minimum number of times.

17. The method of claim 15, further comprising:
determining, with the computing system, a number of times that the load differential exceeds the predetermined differential threshold range within a time period; and
determining, with the computing system, that the second disk blade is damaged when the number of times that the load differential exceeds the predetermined differential threshold range within the time period exceeds a minimum number of times.

18. A system for detecting proper disk blade soil penetration depth on an agricultural implement, the system comprising:
a disk blade assembly including a hanger having a forward arm and an aft arm, the disk blade assembly further including a first disk blade rotatably coupled to the forward arm and a second disk blade rotatably coupled to the aft arm;
a first load sensor mounted on the forward arm of the hanger and configured to generate data indicative of a first load being applied to the forward arm of the hanger;
a second load sensor mounted on the aft arm of the hanger and configured to generate data indicative of a second load being applied to the aft arm of the hanger;
a computing system communicatively coupled to the first and second load sensors, the computing system configured to:
determine a first magnitude of the first load being applied to the forward arm of the hanger based on the data generated by the first load sensor;
determine a second magnitude of the second load being applied to the aft arm of the hanger based on the data generated by the second load sensor; and
determine when the first or second disk blades are not at a selected soil penetration depth based on the determined first and second magnitudes.

19. The system of claim 18, wherein, when determining when the first blade is not at the selected soil penetration depth, the computing system is further configured to:
determine a soil penetration depth of the first disk blade based on the determined first magnitude;
compare the determined soil penetration depth of the first disk blade to a predetermined depth threshold range;
determine that the soil penetration depth of the first disk blade is not at the selected soil penetration depth when the soil penetration depth of the first disk blade is outside of the predetermined depth threshold range; and
initiate a control action when the determined that the soil penetration depth of the first disk blade is not at the selected soil penetration depth.

20. The system of claim 18, wherein, when determining when the second disk blade is not at the selected soil penetration depth, the computing system is further configured to:
determine a soil penetration depth of the second disk blade based on the determined second magnitude;
compare the determined soil penetration depth of the second disk blade to a predetermined depth threshold range;
determine that the soil penetration depth of the second disk blade is not at the selected soil penetration depth when the soil penetration depth of the second disk blade is outside of the predetermined depth threshold range; and
initiate a control action when the determined soil penetration depth of the second disk blade is not at the selected soil penetration depth.
